(19) United States
(12) Patent Application Publication
(10) Pub. No.: US 2014/0324647 A1
(43) Pub. Date: Oct. 30, 2014

(54) CLOUD SERVICES EXPENDITURE ANALYTICS

(71) Applicants: ILYAS IYOOB, AUSTIN, TX (US); AARON MICHAEL YAN, AUSTIN, TX (US)

(72) Inventors: ILYAS IYOOB, AUSTIN, TX (US); AARON MICHAEL YAN, AUSTIN, TX (US)

(73) Assignee: GRAVITANT, INC., AUSTIN, TX (US)

(21) Appl. No.: 14/324,213

(22) Filed: Jul. 6, 2014

Related U.S. Application Data
(63) Continuation-in-part of application No. 14/140,443, filed on Dec. 24, 2013.
(60) Provisional application No. 61/789,865, filed on Mar. 15, 2013.
(60) Provisional application No. 61/790,536, filed on Mar. 15, 2013.
(60) Provisional application No. 61/792,998, filed on Mar. 15, 2013.
(60) Provisional application No. 61/798,567, filed on Mar. 15, 2013.

(51) Int. Cl. G06Q 40/00

(52) U.S. Cl. CPC G06Q 40/12
USPC 705/30

(57) ABSTRACT

A method is provided for analyzing cloud services expenditures. The method determines and displays an amount spent on cloud services for a cloud account is performed. The amount spent includes an amount spent on the cloud services for a current day of the cloud services billing period and all days of the cloud services billing period prior to the current day. The method determines and displays an estimated billed amount for cloud services for the cloud account over an entire duration of the cloud services billing period is performed. The method determines and displays a capacity cost parameter indicating a relationship between the amount spent on the cloud services and a portion thereof that is allocated to capacity-specific contributors of the cloud services is performed.

This continuation-in-part non-provisional United States patent application claims priority from the co-pending United States non-provisional patent application having Ser. No. 14/140,443 filed Dec. 24, 2013 entitled “ASSESSMENT OF BEST FIT CLOUD DEPLOYMENT INFRASTRUCTURES”, having a common applicant herewith, and being incorporated herein in its entirety by reference; which claims priority from United States provisional patent application having Ser. No. 61/789,865 filed Mar. 15, 2013 entitled “SYSTEMS, METHODS AND COMPUTER READABLE MEDIUMS FOR IMPLEMENTING CLOUD SERVICE BROKERAGE PLATFORM FUNCTIONALITIES”, having a common applicant herewith, and being incorporated herein in its entirety by reference; and from United States provisional patent application having Ser. No. 61/790,536 filed Mar. 15, 2013 entitled “CLOUD SERVICE BROKERAGE (CSB) PLATFORM ARCHITECTURE/PORTAL USE CASE IMPLEMENTATIONS”, having a common applicant herewith, and being incorporated herein in its entirety by reference; and from United States provisional patent application having Ser. No. 61/792,998 filed Mar. 15, 2013 entitled “CLOUD SERVICE BROKERAGE (CSB) PLATFORM PORTAL AND CSB PLATFORM ARCHITECTURE FOR PROVIDING SAME”, having a common applicant herewith, and being incorporated herein in its entirety by reference; and from United States provisional patent application having Ser. No. 61/798,567 filed Mar. 15, 2013 entitled “SYSTEM, METHODOLOGY, AND COMPUTER READABLE MEDIUM FOR PROVIDING CLOUD SERVICE BROKERAGE (CSB) PLATFORM FUNCTIONALITIES”, having a common applicant herewith, and being incorporated herein in its entirety by reference.

### FIELD OF THE DISCLOSURE

The disclosures made herein relate generally to analysis of cloud services expenditure data and, more particularly, to analysis of data defining current cloud services expenditures within a portion of a given timeframe for assessing effectiveness and efficiency of such cloud services expenditures.

### BACKGROUND

Cloud computing refers to the practice of using a network of remote servers hosted on a public network (e.g., the Internet) to deliver information computing services (i.e., cloud services) as opposed to doing so on a local server. The network architecture (e.g., virtualized information processing environment comprising hardware and software) through which these cloud services are provided to service consumers (i.e., a cloud service consumers) is referred to as “the cloud”, which can be a public cloud (e.g., cloud services provided publicly to cloud service consumers) or a private cloud (e.g., a private network or data center that supplies cloud services to only a specified group of cloud service consumers within an enterprise), or a community cloud (e.g., a set of cloud services provided publicly to a limited set of cloud service consumers, e.g., to agencies with a specific State/Region or set of States/Regions), dedicated/hosted private cloud, or other emerging cloud service delivery models. The underlying intent of cloud computing is to provide easy, scalable access to computing resources and information technology (IT) services to cloud service consumers.

Cloud services can be broadly divided into four categories: Infrastructure-as-a-Service (IaaS), Platform-as-a-Service (PaaS), Software-as-a-Service (SaaS), and Managed Services. Infrastructure-as-a-Service refers to a virtualized computing infrastructure through which cloud services are provided (e.g., virtual server space, network connections, bandwidth, IP addresses, load balancers, etc). Platform-as-a-Service in the cloud refers to a set of software and product development tools hosted on the cloud for enabling developers (i.e., a type of cloud service consumer) to build applications and services using the cloud. Software-as-a-Service refers to applications that are hosted on and available on-demand by cloud service consumers via the cloud. Managed Services refers to services such as backup administration, remote system administration, application management, security services, etc. that are enabled by managed service providers for any Cloud services.

In general, a cloud service has three distinct characteristics that differentiate it from a traditionally hosted service. The first one of these distinct characteristics is that it is sold to a services consumer on demand (e.g., by the minute or the hour). The second one of these distinct characteristics is that it is dynamic (e.g., a services consumer can have as much or as little of a service as they want at any given point in time). The third one of these distinct characteristics, which applies specifically to public clouds as opposed to private or hybrid clouds, is that the service is fully managed by a cloud services provider (e.g., the services consumer only needs a suitably equipped client device and network connection). This third functionality is particularly relevant to public clouds. However, private clouds can be managed by an internal IT department or through ITO (IT Outsourcing) contracts. In these examples, I&O (Infrastructure & Operations) administrators act as the cloud provider and, accordingly, this third functionality would be of similar relevance.

The cloud is rapidly being adopted by business and IT users as a way to make their organizations more effective and to save costs. Along with this opportunity comes a new set of pain points and significant risks to enterprises that must be addressed. For example, business users are rapidly investing in their own cloud capabilities (e.g., IaaS, PaaS, and SaaS) to meet business needs while application developers want to move rapidly without the involvement of IT to provision tools and environments. These actions are creating a significant threat to IT management whom are worried about considerations such as, for example, managing costs, chargeback, capacity and resources from the result of unrestrained/unplanned cloud expansion.

FIG. 1 shows an example of a traditional cloud management model 100 leading to business unit cloud service users 105 and IT organization cloud service users 108 (i.e., cloud service users) of a cloud service consumer 110 (e.g., a business, an institution, an individual or the like) directly implementing cloud services via cloud service providers 115 (e.g., IaaS, PaaS, SaaS, ERP, and MS available on one or more outside networks) without oversight and/or involvement of a centralized resource (e.g., IT management). ERP refers to enterprise resource planning and MS refers to Managed Services such as security, backup, monitoring and governance services offered by cloud service providers or a CSB platform provider (i.e., the entity that manages and administers the CSB platform). Examples of the cloud service categories include, but are not limited to, enterprises resource planning services, Infrastructure as-a-Service (IaaS), Platform-as-a-Service (PaaS), Software-as-a-Service (SaaS), and managed services.

There are numerous challenges and limitations in regard to implementing and managing cloud services that arise from the traditional cloud management model 100 discussed above in reference to FIG. 1. Examples of these challenges and limitations include, but are not limited to, different portions (e.g., user, entities, departments, etc) of a given cloud service consumer individually buying cloud services; different portions of a given cloud service consumer purchasing cloud services at different price points from the same cloud services provider; actions of different portions of a given cloud service consumer creating gaps in current business entity processes; disparate billing, payment, contract and settlement process for cloud services of a given cloud service consumer being created; IT interests of a given cloud service consumer being required to undertake actions such that it mimic a cloud service provider; existence of inconsistent service management and service-level-agreement (SLA) compliance across cloud service providers; and loss of effectiveness in implementing and managing cloud services due to broken processes across business, IT demand and supply organizations.

Accordingly, underlying problems that exists in cloud computing is that the need for intermediaries to aggregate, integrate or customize cloud services and that this need grows significantly as the number of cloud services and the rate of consumer adoption grows. Without such intermediaries being able to effectively and efficiently manage cloud services, cloud service consumers must manage numerous transactions (e.g., payments, governance, data movement, customization and enrichment) associated with their cloud service providers and cloud services. This can rapidly become a task that is difficult, time-consuming and expensive, especially when they are consuming numerous cloud services from independent providers. Furthermore, traditional approaches for managing cloud services leads to the adverse situation of vendor “lock-in” in which cloud service consumers are undesirably tied to a particular vendor or set of vendors for all or a portion of their cloud services.

It is well known that preparation and analysis of bills for complex expenditures such as, for example cloud computing expenditures can be challenging. There can be many reasons for this. One such reason is that it can be difficult to concisely communicate actionable details that are necessary for allowing these expenditures to be analyzed in a relatively simple and conclusive manner. Another such reason is that, traditionally, bills for these types of expenditures do not conveniently provide information about daily spending. Still another such reason is that bills for these types of expenditures do not alert customers of undesired charges.

For cloud computing expenditures and other similar types of expenditures, it is not uncommon for end-of-month bills to include hundreds or thousands of line-items that detail various aspects of charges, transactions, and usage. Manually parsing this information is tedious. Furthermore, such an end-of-month bill provides only a snapshot of the information defining the final amount due to the service provider. This means that such bills lack information related to expenditures over time and how these expenditures change on a per-timeframe (e.g., per day) basis. Lastly, cloud service providers do not alert cloud service consumers (i.e., customers) of unnecessary spending, which can require a cloud service consumer to manually check their accumulating bill each day for managing their daily expenditures.

Therefore, a solution that provides a convenient means for transparently monitoring and diagnosing expenditures for cloud computing and other activities having similar expenditure characteristics and billing requirements would be beneficial, desirable and useful.

### SUMMARY OF THE DISCLOSURE

Embodiments of the present invention are directed to solutions that provide a convenient means for transparently monitoring and diagnosing expenditures for cloud computing and other activities having similar expenditure characteristics and billing requirements. More specifically, embodiments of the present invention are directed to analysis of data defining current expenditures within a portion of a given timeframe for determining an estimated total amount of such expenditures for the given timeframe. In doing so, embodiments of the present invention advantageously overcome various shortcomings associated with conventional approaches for preparation and analysis of expenditure data. Examples of these shortcomings include, but are not limited to, end-of-month billing that provides only a snapshot of information defining the final amount due to a service provider, bills lacking information related to expenditures over time and how these expenditures change on a per-timeframe (e.g., per day) basis, lack of notification to the cloud service consumer of unnecessary spending, and the like.

In one embodiment of the present invention, a non-transitory computer-readable storage medium has tangibly embodied thereon and accessible therefrom instructions interpretable by at least one data processing device. The instructions are configured for causing the at least one data processing device to perform a method for providing analysis of cloud services expenditures. The method determines and displays an amount spent on cloud services for a cloud account is performed. The amount spent includes an amount spent on the cloud services for a current day of the cloud services billing period and all days of the cloud services billing period prior to the current day. The method determines and displays an estimated billed amount for cloud services for the cloud account over an entire duration of the cloud services billing period is performed. The method determines and displays a capacity cost parameter indicating a relationship between the amount spent on the cloud services and a portion thereof that is allocated to capacity-specific contributors of the cloud services is performed.

In another embodiment of the present invention, a non-transitory computer-readable storage medium has tangibly embodied thereon and accessible therefrom instructions interpretable by at least one data processing device. The instructions are configured for causing the at least one data processing device to perform a method for providing analysis of cloud services expenditures. The method determines, on a daily basis for each day since a first day of a cloud services billing period, an incremental cost amount of cloud services for a cloud service consumer account. The method determines an estimated billed amount for the cloud services over an entire duration of the cloud services billing period. Determining the estimated billed amount includes applying a weighting factor in its entirety to the incremental cost amount for a current day of the cloud services billing period and applying a weighting factor remaining portion in an equally divided manner to the incremental cost amount for each day of the cloud services billing period prior to the current day.

In another embodiment of the present invention, a non-transitory computer-readable storage medium has tangibly embodied thereon and accessible therefrom instructions interpretable by at least one data processing device. The instructions are configured for causing the at least one data processing device to perform a method for providing analysis of cloud services expenditures. The method receives, on a current day of a cloud services billing period, a request for cloud service spending information for a cloud account, wherein the cloud account has a plurality of cloud service consumer accounts associated therewith. The method prepares and displays, in response to receiving the request for the cloud service spending information, a cloud account spending summary for the cloud account. The cloud account spending summary includes a current amount spent on cloud services for the cloud service consumer accounts and an estimated billed amount for cloud services for the cloud service consumer accounts over an entire duration of the cloud services billing period. In response to receiving selection of a particular one of the cloud service consumer accounts, the method prepares and displays a cloud service consumer account spending summary for the particular one of the cloud service consumer accounts. The cloud service consumer account spending summary includes a current amount spent on cloud services for the particular one of the cloud service consumer accounts and an estimated billed amount for cloud services for the particular one of the cloud service consumer accounts over an entire duration of the cloud services billing period.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is an illustrative view showing an example of a traditional cloud management model leading to cloud service users of a cloud service consumer directly implementing cloud services via cloud service providers.

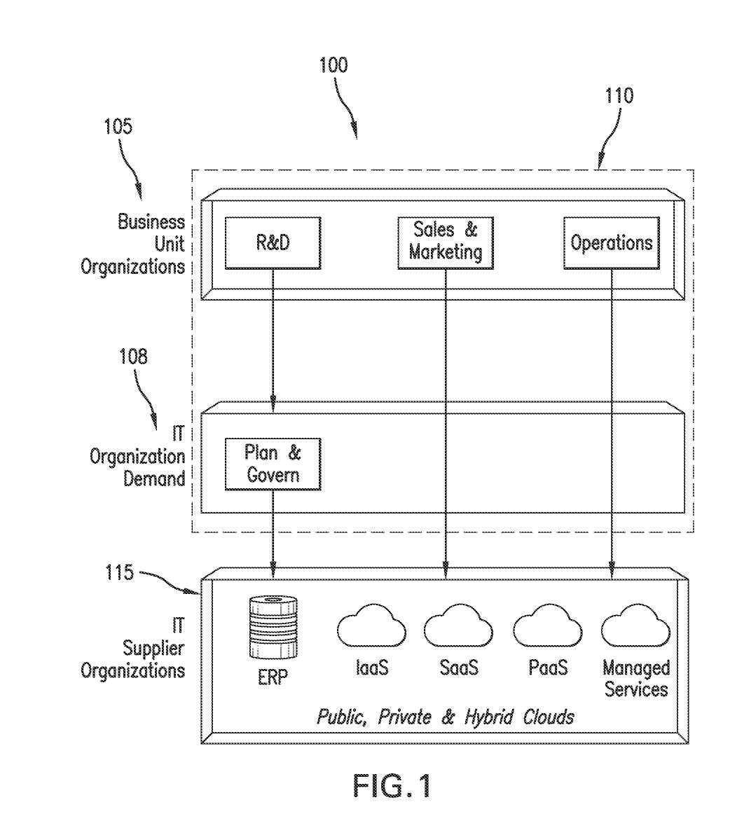

FIG. 2A is an illustrative view showing an example of a cloud management model configured in accordance with an embodiment of the present invention.

FIG. 2B is diagrammatic view showing a detailed implementation of the cloud management model of FIG. 2 as viewed from Cloud Administrator and End User perspectives.

FIG. 3A is a functionality module view of a CSB platform configured in accordance with an embodiment of the present invention.

FIG. 3B is an illustrative view showing a resource solution center configured in accordance with an embodiment of the present invention.

FIG. 4 is an illustrative view showing high-level functionality of the CSB platform of FIG. 3A.

FIG. 5 is an architectural view showing various engines providing functionality the CSB platform of FIG. 3A.

FIG. 6 is a block diagram showing a data processing system 300 representative of a hardware environment comprising a CSB platform configured in accordance with an embodiment of the present invention.

FIG. 7 is a diagrammatic view showing a cloud account spending summary configured in accordance with an embodiment of the present invention.

FIG. 8 is a diagrammatic view showing a cloud service consumer account spending summary configured in accordance with an embodiment of the present invention.

FIG. 9 is a diagrammatic view showing a sub-account overview configured in accordance with an embodiment of the present invention.

FIG. 10 is a diagrammatic view showing a daily cost ledger configured in accordance with an embodiment of the present invention

### DETAILED DESCRIPTION

### CSB Platform Architecture

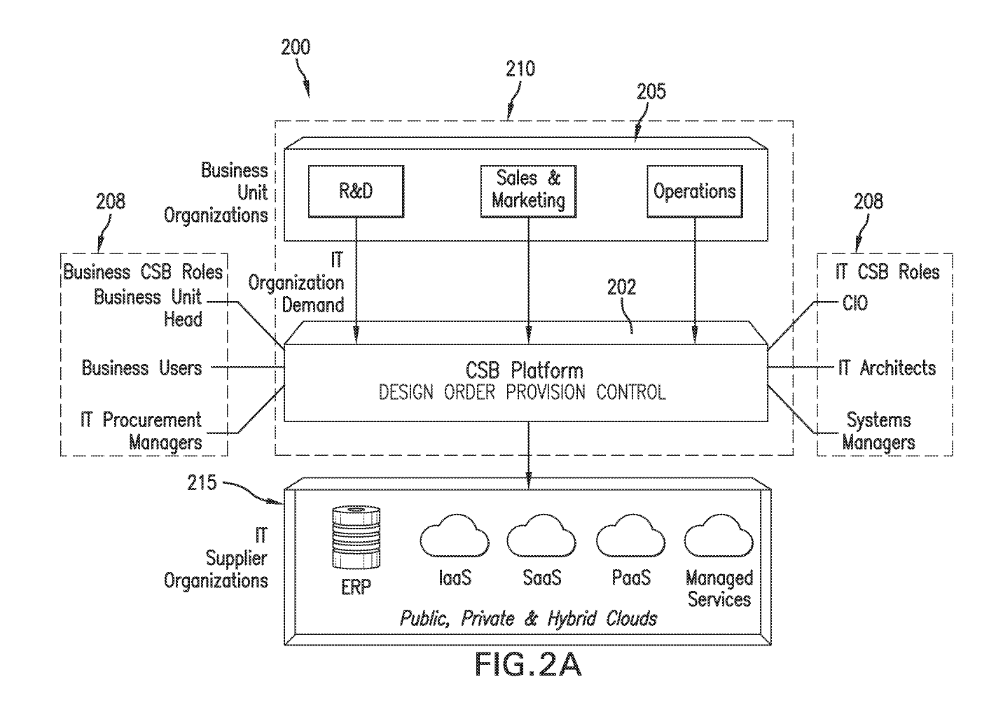

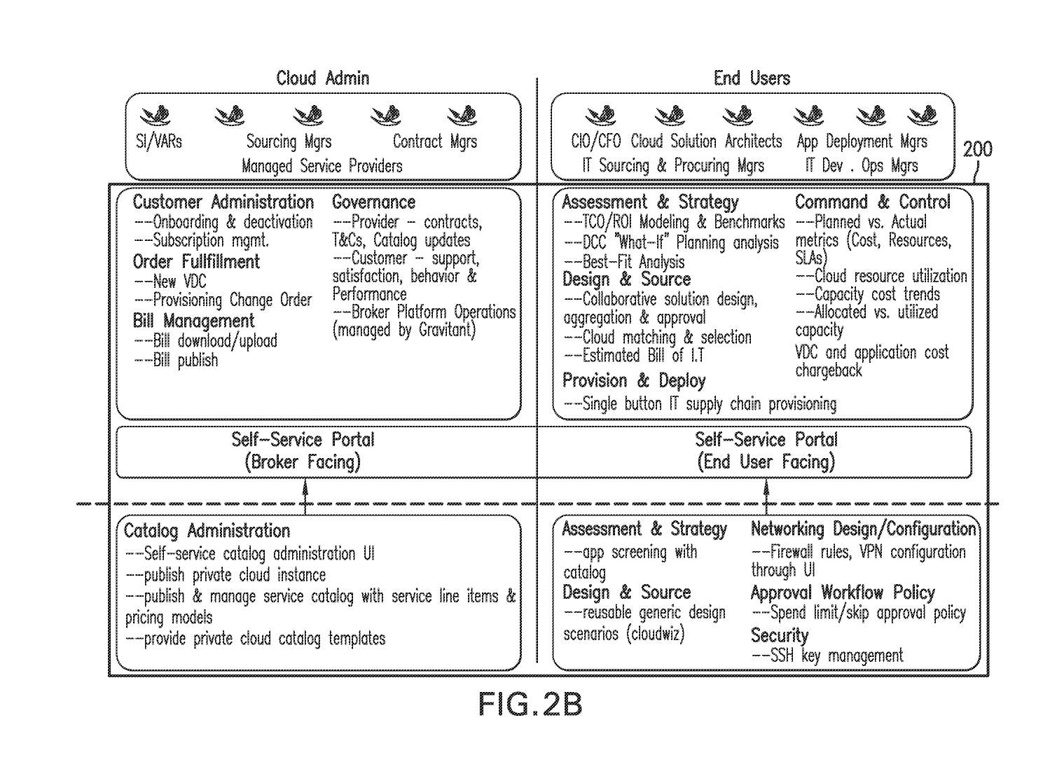

Referring to FIGS. 2A and 2B, various aspects of a cloud management model 200 configured in accordance with an embodiment of the present invention are shown. Advantageously, the cloud management model 200 implements a CSB platform 202 through which business unit cloud service users 205 and CSB role cloud service users 208 (i.e., cloud service users) of a cloud service consumer 210 access cloud services via cloud service providers 215 (e.g., providing services via one or more outside networks with respect to the CSB platform 202). The CSB platform 202 enables cloud service users of the cloud service consumer 210 to enhance the manner in which it implements cloud consumption across public, private and hybrid clouds. For example, the CSB platform 202 enables cloud service users of the cloud service consumer 210 serving in an IT capacity (e.g., IT architects, system managers, information executives and the like) to limit the complexities and risks of implementing cloud services across multiple providers, allowing for increased agility, standardization of a cloud consumption model, formalization of accounting processes and implementation of compliance and governance.

The CSB platform 202 can be implemented in a variety of manners. In a first implementation, the CSB platform 202 is implemented in a manner where it enables an entity to be a trusted cloud service provider for its own customer base (i.e., its own cloud service consumers), to set up and manage secure virtual data centers with multiple cloud providers, and to add third party services such as security, monitoring and backup to build a more complete solution. In this first implementation, the CSB platform 202 serves as a single interface through which this users in customers with a single interface through which the cloud service consumers can design, order, provision, and manage not just cloud services but also traditional IT services have been provided to them in the past. In a second implementation, the CSB platform 202 is implemented in a manner where it enables an IT organization to maintain complete cost and SLA visibility and governance, while providing its users with a single interface through which they can design, order, provision, and control infrastructure and platform services from a myriad of public, private, hybrid and colocation providers.

The CSB platform 202 has a plurality of associated entities that directly or indirectly interact with it. Though the roles and responsibilities can vary for in certain implementations based on the needs of the specific brokerage, following is a summary of such entities. Broker refers to an entity that owns a cloud service brokerage. The Broker is responsible for contractual oversight of the brokerage, governance, and communication to agencies & consumers to facilitate and increase adoption. The Broker may take on additional roles that can be delegated to the Broker Operator. These additional roles are billing intermediary between broker operator and consumer agency and payment handling. Broker Operator refers to an entity that runs the business operations of the brokerage (e.g., billing management & invoicing, Provider agreements, SLAs and relationship management, pricing management, customer on-boarding including customer agreements, etc.) and technical services (e.g., federated help desk, new provider on-boarding, cloud architecture and design services, additional integrations and customizations, migration services, application management services, other managed services). Some of these roles may be a separate entity such as a System Integrator. For example, if the Broker chooses to manage the business operations and act as the Broker Operator, the Broker may choose to have a System Integrator or vendor perform the technical services. Brokerage Platform Operator refers to the entity that maintains and provides access to the CSB platform. Its responsibilities can include deployment, ongoing upgrades and release management, technical operations, level 3 support for the brokerage portal, etc. Cloud Service Provider refers to the entity that provides the requested cloud services, technical support for published APIs, monthly metering and billing, meet SLAs and provider terms, Level 3 support for provisioned resources, participate in critical problem triage and resolution processes, solution design review and approve (optional), etc. Cloud service consumer refers to an entity that is a register user on a portal of the platform. The Cloud Service Consumer manages users and access control through role assignments, sets spending limits and purchase orders, undertakes cloud architecture and solution design, accesses and uses provisioned resources, receives monthly bills, reviews bills and details through portal, pays bills, monitors performance using the performance dashboards/analytics for cost, capacity and utilization, etc.

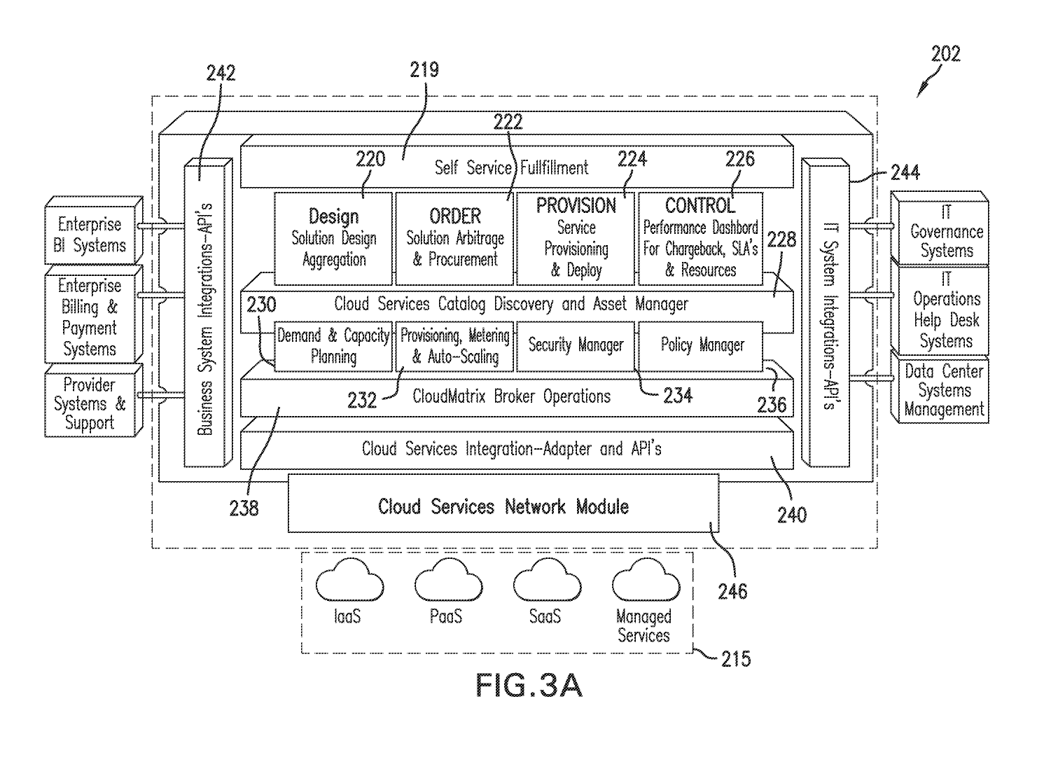

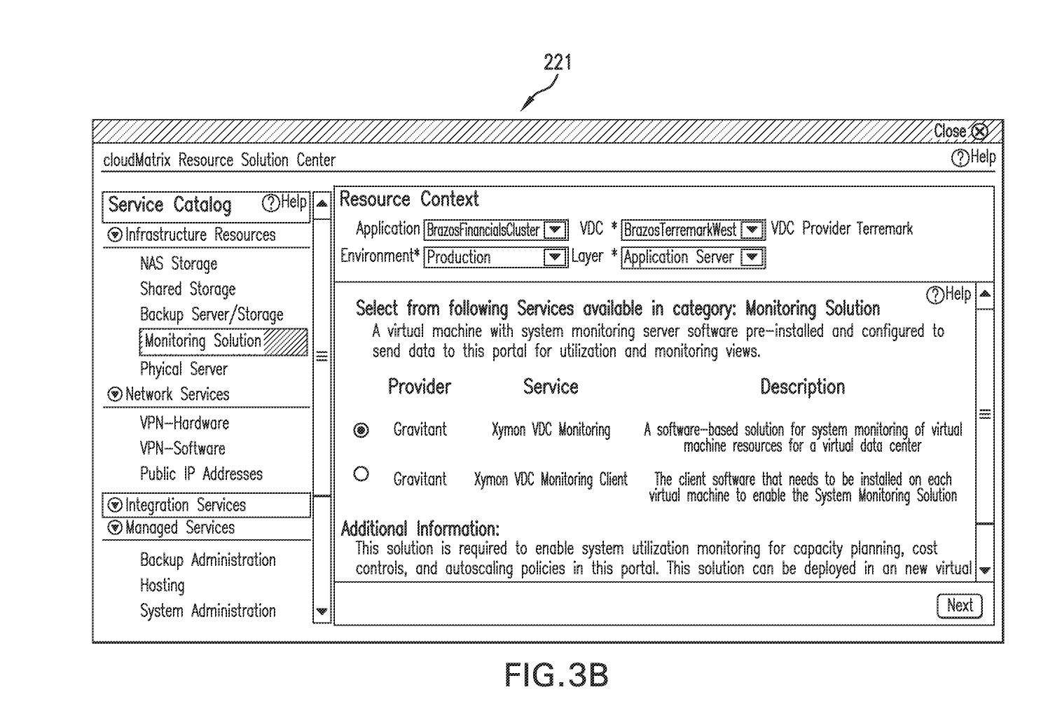

FIG. 3A shows a functionality module view of the CSB platform 202 (i.e., a CSB platform configured in accordance with an embodiment of the present invention). The CSB platform 202 serves as a cloud services brokerage and management platform that integrates multiple cloud provider services (e.g., internal or external) into a CSB platform portal through which cloud service consumers (e.g., business enterprises) can manage (e.g., optimize) the design, provisioning, ordering and control (i.e., consumption) of cloud services. One example of such a CSB platform portal is provided by Gravitant Inc. at the URL mygravitant.com. Cloud service consumers can deploy core services and features enabled by the CSB platform 202, which are described below in greater detail, through a single user interface of a cloud user accessible portal. These core services and features can be deployed independently or as an integrated suite of cloud services based on specific cloud service needs of a particular cloud service consumer. Advantageously, the CSB platform 202 is technology agnostic and will work and leverage current cloud platforms and business systems deployed of a cloud service consumer.

Advantageously, the CSB platform 202 offers numerous capabilities for allowing a cloud service consumer 210 to enable its cloud service users to implement (e.g., design, order, provision and control) cloud services across public, private and hybrid clouds. Examples of these capabilities include, but are not limited to enabling internal business and IT units to offer their cloud service users a single interface to design, order, provision and control virtual data centers (VDC) in public, private and hybrid infrastructure services; setting up a central environment for carrying out sourcing, procurement, fulfillment and billing processes and contracts with preferred public and private cloud providers; and tracking usage, chargeback, Quality of Service (QoS), SLA's and performance of internal and external cloud infrastructure service providers. Furthermore, the CSB platform 202 enables integration with current IT infrastructure and automation of investments made by a cloud service consumer. Still further, the CSB platform 202 includes a multi-cloud services catalog with services from available public cloud providers (e.g., Amazon, GoGrid, Terremark and Savvis). Accordingly, a cloud service consumer can use a private cloud catalog and service package template to quickly operationalize an enterprise CSB solution. Examples of template content, which are discussed below in greater detail, include service options relating to design and aggregation (i.e., cloud service designing); cloud service sourcing, arbitrage and procurement (i.e., cloud service ordering); service/user provisioning and deployment (i.e., cloud service provisioning); performance dashboards for chargeback, SLA's and resources (i.e., cloud service control); cloud services catalog and asset manager; cloud demand and capacity planning; provisioning, metering and auto-scaling; security management; policy management; broker operations management; cloud services integrations (e.g., adapters & APIs); business systems integrations (e.g., APIs); IT systems integrations (e.g., APIs); and cloud services networking.

In regard to the multi-cloud services catalog (i.e., the catalog), it is highly customizable. Self-service administrative capabilities (e.g., via the self-service fulfillment module 219) are available for the broker to perform actions such as, for example, setting up new cloud services, modifying existing cloud services, customizing the cloud service parameters, updating pricing, reclassifying services, and adding or removing providers. Broadly speaking, the catalog supports an abstraction of marketplace services and categorizations that then maps to provider specific catalog line items. In this regard, a cloud services catalog provides a service abstraction that can map to one or more provider services/line items. For example, a VM service on Savvis maps to vCPU, memory and local storage services with OS templates. For Terremark, Savvis, Amazon, Amazon GovCloud, the aggregated VM services are pre-defined and published in the catalog. Additionally, attributes that are specific to cloud service consumers such as, for example, pricing rules, security and access constraints can be defined in the same catalog. This allows for a high degree of function and flexibility. For example, a consumer level service may be a packaged VM, which may translate into multiple provider catalog line items thereby significantly reducing complexity of the cloud for the consumer. This also simplifies maintenance as well as enables comparison of cloud services and plans from different providers. Accordingly, it will be appreciated that the CSB platform 202 can be configured with an integrated catalog and solution configurator that provides a unique capability to access services from providers that are required to enable a cloud service consumer solution. This integrated catalog and solution configurator provides transparency of provider capabilities and enables the customer to make the right choices from a technology, operational and management perspective.

The catalog has predefined metadata for service providers and services such as capacity limits, and allowed capacity configurations for CPU, memory, local storage, NAS storage etc. for different providers. These constraints are then applied at the time of solution design and Architecture. The total capacity being procured is also displayed to the user while the solution is being iteratively designed. If the predefined capacity limits are exceeded, warning and error messages can be displayed to the user as appropriate. With the ability for the cloud provider to have predefined capacity configurations such as specific vCPU sizes, specific RAM sizes, and storage blocks, it makes the catalog more end-users friendly and self-service. Through use of a catalog administration capability, an operator of the CSB platform 202 can update the metadata of the catalog to change the limits and predefined capacity configurations. For the cloud service providers already integrated into the CSB platform, these capacity configurations have already been defined as part of the content that is available as pre-configured selections.

FIG. 3B shows a resource solution center 221. The resource solution center 221 serves as a single point (e.g., one-stop) source for all of virtual resource service needs of a user of the CSB platform 202, in FIG. 3A. The resource solution center 221 correlates service catalog line items to an available cloud service selection (i.e., a resource context). Through the resource solution center 221, a user can identify and add infrastructure services such as, for example, shared storage and backup services; network services such as VPN; and managed services such as back-up administration and security management. Examples of infrastructure services include, but are not limited to shared storage (e.g., a cloud-based storage service for backup server software and shared backup storage) and a monitoring solution (e.g., a VM with system monitoring server software pre-installed and configured to send data to this portal for utilization and monitoring views). Examples of network services include, but are not limited to, VPN hardware (e.g., a hardware-based Virtual Private Network (VPN) solution that enables a Site to Site VPN managed by the VDC provider) and VPN software (e.g., software-based VPN solutions that allow for a lower cost secure VPN gateway and can enable Client to Site and Client to Site VPN). Examples of managed services include, but are not limited to, backup administration (e.g., services offered by IT operations service providers to configure backups, maintain backup schedules, monitor and verify backups, and restore backups as needed); system administration (e.g., services offered by IT operations service providers to setup, configure, and support cloud environments, including systems, virtual machines, storage, and networks); and security management (e.g., services offered by IT operations service providers to setup operational security policies, manage virtual private networks, and manage ongoing security, including audits and compliance).

Referring to FIG. 3A, a design module 220 of the CSB platform 202 enables (e.g., via a CSB platform access portal interface (i.e., part of the self-service fulfillment module 219) of the CSB platform 202) comprehensive cloud planning services (i.e., solution design and aggregation functionality). Cloud adoption scenarios can be simulated using prediction analytics for business applications and infrastructure resource needs. Demand, capacity, cost (TCO) and ROI baselines can be forecasted and established for each cloud solution and the internal and/or external cloud service platforms being used. Scenario dashboards can be saved and published and used to provide access to business organizations, IT resources, vendors and the like to align all parties on goals and implementation activities. Examples of information generated and tasks implemented using the design module 220 include, but are not limited to, visual architecture management; solution design and aggregation; application definition and management; and solution scenario design. Accordingly, a skilled person will appreciate that benefits of the design module 220 include, but are not limited to, accurately simulating and predicting cloud capacity and cost for a given application demand profile; clearly understanding cloud capacity needs and cost for each cloud provider before making investment decisions; running cloud consumption scenarios to understand cost, capacity and demand trade-offs/risks; accurately setting IT budgets for cloud computing projects; comparing cloud capacity, costs and SLAs across cloud provider offerings and platforms; clearly establishing and track ROI and TCO metrics for each cloud solution and project; and controlling and managing IT assets in the cloud and reduce cloud/virtual machines (VM) and subscription sprawl.

A virtual machine (VM) refers to a virtual computer that uses the resources of one or more real computers, but which is functionally indistinguishable from a physical computer running the same software from an end user's perspective. For example, in case in which there is a need to set up a new mail server, instead of buying a server (which may only actively process email 1% of the time), installing and configuring the mail server, configuring and maintaining networking for the server, and paying for the electricity and maintenance for the server, a cloud service consumer can pay a cloud service provider to set up a virtualized mail server. This server would run all the same software as the physical server, but would live in a VM that sits atop one or more physical servers which have (at a minimum) the same capabilities (CPU, memory, storage) as the local physical server necessary to run the same software. In turn, this same hardware used by the cloud service provider may support multiple other VMs, none of which use all the hardware system's resources. The cloud service users of the cloud service consumer would send and receive mail from this VM server exactly the same way they would if the server was physically located on premises of the cloud service consumer. In contrast, a virtual data centers (VDC) is similar to physical data centers. A VDC allows dynamic creation of virtual resources atop a physical infrastructure, including CPU, memory, storage, and network capacity. A VDC can be thought of as a container for a VM or as a server rack. Just as a server rack itself does not run any applications, a VDC does not itself run any applications; each is provisioned with servers (e.g., VMs) that run applications. VDC resources can be created on-demand and managed as a pool of virtual resources and controlled through an online user interface. Instead of ordering specific line items from a catalog, VDC is designed with capacity and/or virtual resources and then the system automatically generates an order for the provider to fulfill that VDC design. A VDC can be deployed on internal physical/virtual environments or in public clouds. A VDC can comprise of VMs, storage, one or more networks (subnets), VPNs, Firewalls, load balancers, and any other infrastructure as a service.

Still referring to FIG. 3A, the above-mentioned solution design and aggregation functionality implemented via the design module 220 often entails conducting an “apples-to-apples” comparison of cloud services from a variety of cloud service providers. However, quite often, each cloud service provider has a different style of presenting cloud services and resources to the end-consumer. At a high level, even their business models vary in the sense that certain providers employ reserved capacity vs. on-demand capacity methods of enabling a consumer to procure cloud resources. The CSB platform 202 is configured with a plurality of methods to perform such comparisons.

One method for performing such comparisons is through use of a cloud services planning wizard. An underlying component of the cloud services planning wizard is a metric parameter referred to as a Capacity Unit (CU), which is central to enabling precise cloud service comparative capabilities for measuring, comparing, metering and enforcing quality, performance and cost standards across cloud vendors for different cloud services. The CU is a generic unit of IT capacity that is a function of multiple factors such as, for example, processor speed, random access memory, storage, and bandwidth. In one specific implementation, 1 CU=the capacity to compute at a speed of 2.4 GHz with random access memory of 4 GB and local storage of 100 GB through 1 Mbps of bandwidth. It should be noted that the CU value scales differently with respect to each factor and its value intends to represent the effective realization of the individual capacity components.

By employing the cloud services wizard (which can include an application screener) to assess information derived from a knowledge base of information based on experience and best practices and to calculate CUs for various cloud service providers, the CSB platform user is guided towards an apples-to-apples comparison that results in the closest matched cloud services and cloud service providers. In at least one implementation, the cloud services wizard takes into account dimensions such as, for example, virtual machine dimensions (e.g., memory, CPU/vCPU, local storage, etc); network dimensions (bandwidth desired, virtual LAN, guaranteed throughput, pricing models, load balancers, public vs. private networks, etc); storage dimensions (e.g., defining different architectures, ability to snapshot storage, back up strategies for storage as well as offering shared storage, etc); security dimensions (e.g., firewalling technologies, intrusion detection/prevention technologies, etc); service level agreements (e.g., availability monitoring and service crediting); operating systems supported (e.g., employing templates with licenses, 32/64 bit operating systems, support for blank servers, virtual machines registered and compliant with certain operating systems, etc); provisioning times (e.g., for virtual machines, for provisioning the first virtual data center vs. subsequent virtual data centers, etc); support for virtual resources (e.g., varying from free, forum based support to full helpdesk support that is included for no additional fees); designation of location of virtual resources (e.g., geographic designation and specific locales based on CSP data center availability); and virtual resource pricing structure (e.g., varying by sizing of packages vs. individual resources that may vary by pricing model for reserved capacity vs. on-demand capacity).

Another method for performing such comparisons is through use of a service offerings comparator. By using a normalized scheme of small, medium and large cloud service packages (or other custom packages) of well-defined capacity including compute, storage and memory with normalized utilizations and allocation models, the CSB platform provides a quick pricing comparison for these multiple packages across cloud services and providers.

Still referring to FIG. 3A, the CSB platform 202 supports two models for creating and accessing accounts on the cloud service providers that it manages—Broker managed provider accounts and Customer managed provider accounts. The brokerage can be configured to support both models or either the Customer managed model or Broker managed model. In the broker managed provider accounts model, for example, a broker operations team creates accounts for each cloud provider and inputs the credentials to the portal based on customer (e.g., user) requests. Alternately, a broker can also have reseller relationships with the providers to have predefined accounts which can be set up in the system, and when a customer orders services, the broker simply assigns one of the predefined accounts to this customer. In the customer managed provider accounts model, for example, the customer may already have provider accounts or would prefer to directly create and manage the provider accounts. The customer sets up the account in CSB platform portal and provides the provisioning credentials, and billing credentials, if any. The brokerage portal can then perform all the functions such as catalog, solution design, order approval workflows, screening, provisioning, billing load by customer, cost allocation, dashboards, etc.

An order module 222 of the CSB platform 202 enables (e.g., via the CSB platform access portal) broker services enabling business and IT users the ability to engage with cloud service providers for building business and technology relationships (i.e., sourcing, arbitrage and procurement functionality). It offers a central point for a cloud service consumer to quickly aggregate cloud solutions, procure and pay for them by combining cloud services from different providers to meet business needs, cost constraints and innovation requirements. Examples of information generated and tasks implemented using the order module 222 include, but are not limited to, bill of materials estimates, advanced pricing rules, service offering comparators, provider account management, and procurement process flow. Accordingly, a skilled person will appreciate that benefits of the order module 222 include, but are not limited to, quickly setting up enterprise procurement portal(s) and streamlining cloud acquisition processes across business and IT organizations; meeting new business demand or scalability by having access to multiple cloud providers; ready access to cloud services from internal and external providers with integrated provisioning and procurement processes; being aligned with cloud market changes including product, pricing, packaging, and SLA changes from vendors; reducing cloud costs by comparing cloud service combinations for any given solution; performing real-time spend analysis across providers; optimizing as provisioning and de-provisioning systems are integrated with billing and order management; and reducing time and cost in billing, metering and payment management though a centralized bill and payment capability.

A provision module 224 of the CSB platform 202 enables (e.g., via the CSB platform access portal) cloud management services for users through a single view of cloud services resources from internal or external providers (i.e., service/user provisioning and deployment functionality). A cloud service consumer (e.g., an enterprise IT department) can use the provision module 224 to design application architectures and setup virtual data centers across multiple internal and external providers and manage it from one central location. Furthermore, cloud service consumers can create environments (e.g., Dev, Test, Production and DR) for a business application from different providers and manage them. Examples of information generated and tasks implemented using the provision module 224 include, but are not limited to, automated provisioning and deployment of IaaS and PaaS resource groups/clusters; workflow-based provisioning; auto-scaling service for one or more cloud service providers; and deployment workflow automation. Accordingly, a skilled person will appreciate that benefits of the provision module 222 include, but are not limited to, no vendor or technology lock in, rapid setup of virtual data centers and real time provisioning of IaaS, PaaS, SaaS, Managed Services and other cloud resources across multiple cloud providers, reduced cloud infrastructure costs by continuously optimizing utilization, enhanced resource availability for business applications to meet scalability and performance, enhanced cloud resource allocation to business application and business units, enabling customized cloud data center solutions by adding third party support services, and leveraging current investments in monitoring and management tools sets.

A control module 226 of the CSB platform 202 enables (e.g., via the CSB platform access portal) command and control services that are critical to successful adoption and acceptance of the cloud services model (i.e., dashboard functionality for chargeback, SLAs and resources). A cloud service consumer can gain visibility into current performance, cost and utilization of cloud services and compare against planning benchmarks/milestones to automatically initiate corrective action to continuously optimize cost, resources and SLAs to meet business demand and changes. Furthermore, a cloud service consumer can automatically track, define, establish, and report chargeback against business applications, business units, IT budget codes and/or shared resource categories. The provision module 224 includes a plurality of pre-configured dashboard views for chargeback, SLA's and resources. Examples of the pre-configured dashboard views include, but are not limited to, cloud analysis by virtual data center (VDC), application, customer, and business units/departments; capacity cost trends (e.g., compute, memory, network, managed services analysis of capacity vs. cost and trends over time); cost analysis (e.g., by resource type, environment and layer); capacity summary (e.g., allocated capacity, integrate with utilized capacity); cloud utilization & detailed utilization (e.g., monthly/daily utilization for avg/max of CPU/memory utilization and trends over time; aggregation of utilization data for cloud analysis by VDC, application, environment, layer, and resource groups; drill down to system monitoring tool; adapter based integration with any system monitoring tools; deployment template and provisioning for Xymon monitoring server/clients, and ability to deploy & provision other application and system monitoring technologies; and VDC and application cost chargeback); custom dashboards/reporting and activity logs for audit and tracking; and alerts (e.g., capacity changes, utilization thresholds, cost thresholds, and user access changes). Accordingly, a skilled person will appreciate that benefits of the provision module 222 include, but are not limited to, business and IT Management having visibility and control over the cloud ecosystems, costs, resources and SLAs; eliminating unrestricted/unintended spending with alerts, procurement and provisioning workflows; making more accurate investment decisions that continuously reduce cost and optimizes resource utilization; implementing proactive action on resource, SLA and cost alignment before there is an impact to business; auditing and reporting on all IT financial transactions, owned assets in the cloud by business app, business unit and shared IT resources; real time alignment of business, IT staff, resources, cost and performance; effective cost accounting and cost assignment to specific business units and apps; rapid enablement of IT initiatives for reducing the time between strategic planning and operational execution; continuous baselining of business and IT metrics; and establishing performance benchmarks.

A cloud services catalog and asset manager module 228 of the CSB platform 202 enables (e.g., via the CSB platform access portal) command and control services that are critical to successful adoption and acceptance of the cloud services model (i.e., cloud services catalog and asset manager functionality). Examples of information generated and tasks implemented using the cloud services catalog and asset manager module 228 include, but are not limited to, multi-provider catalog for IaaS, PaaS, SaaS, Managed Services, and Custom Services; extendable and customizable catalog with dynamic attributes and user interface; pricing support for different cloud provider pricing models (e.g., reserved capacity pricing, allocated capacity pricing and pay-as-you-go); manage provisioned assets (e.g., IaaS, PaaS, SaaS, managed and custom services, asset relationships, asset status and life cycle management, etc); automated asset discovery & sync (e.g., discover and make changes to assets in the cloud, sync with assets registered in catalog/asset manager, match process enabling the IT Administrator to resolve any discrepancies, match and compare prices in catalog for discovered assets, etc); and pre-configured content that is pre-populated with several provider offerings for rapid deployment.

A demand and capacity planning module 230 of the CSB platform 202 enables (e.g., via the CSB platform access portal) solution capacity modeling (i.e., cloud demand and capacity planning functionality). Examples of information generated and tasks implemented using the demand and capacity planning module 230 include, but are not limited to, planned vs. allocated vs. utilized capacity; standardized capacity units across cloud providers, cloud models and infrastructure; advanced and dynamic capacity planning (e.g., application capacity model and VDC capacity model; support for shared resources across VDCs, applications, environments and layers; capacity benchmarks using projected utilization profiles; capacity re-baseline using actual utilization data; modeling analysis of forecasted vs. available utilization thresholds for forecasting capacity growth needs, etc); demand planning with business driver-based demand modeling, drivers for normal demand growth or event-based; and integrated demand and capacity planning to update resource capacity and generate schedule or metric-based policies to change resource capacity based on capacity plan.

In regard to demand and capacity planning, the CSB platform (e.g., via the demand and capacity planning module 230) allows a cloud broker (e.g., platform operator) or the end customer (e.g., cloud service customer) to input demand profiles which then get applied to the solution design, and generate a capacity vs. demand curve (e.g., across an IaaS architecture). This enables cloud service consumers to incrementally acquire capacity as the demand grows instead of acquiring a lot of capacity that remains unutilized till the demand catches up. The CSB platform 202 also enables customization of the capacity planning to be tailored to specific customer architectural needs, and complex demand patterns.

A provisioning, metering and auto-scaling module 232 of the CSB platform 202 enables (e.g., via the CSB platform access portal) automated workflow based provisioning, integrated support for secure shell (SSH) based VMs, and deployment automation (i.e., provisioning, metering and auto-scaling functionality). Examples of automated workflow based provisioning include, but are not limited to, asynchronous message-based provisioning across multiple clouds simultaneously; handle and retry provisioning failures workflow to aggregate and manage underlying cloud provisioning task dependencies; hybrid workflow to support combination of automated and manual provisioning tasks; extensible workflow definitions that support custom integrations for Enterprise systems.

A security manager module 234 of the CSB platform 202 enables (e.g., via the CSB platform access portal) various security management functionalities related to cloud services. Examples of such security management functionalities include, but are not limited to, user security management with subscription and role-based access control that allows for multiple models of user security including user group support and password policy, single sign on and advanced security (e.g., support for integration with federated identity and access management systems, enterprise user directory integration, etc); user administration delegation to business units/departments; centralized and delegated user security administration; VPN services and firewall configuration support; VM encryption support across cloud providers; SSH key management for provider accounts, VDCs, and individual VMs; and support for Federal, Enterprise and other custom, high security deployments.

A policy manager module 236 of the CSB platform 202 enables (e.g., via the CSB platform access portal) implementation of various policies related to cloud services. Examples of such policies include, but are not limited to, pricing policies (discounts, upcharges, customer specific, partner specific, custom, etc); cost alerts based on thresholds; resource auto-scale policies (e.g., via support for a policy provider auto-scaling function); cost allocation policies by allocated and utilized capacity; architecture policies to enforce architectural constraints in solution design; and workflow/notification policies (e.g., email groups, portal tasks, order approvals, etc).

A broker operations module 238 of the CSB platform 202 enables (e.g., via the CSB platform access portal) implementation of broker operations related to cloud services. Examples of such broker operations include, but are not limited to, customer activations (i.e., on-boarding) and deactivation; customer subscription management (e.g., subscription packages and payment authorization); customer billing & payments with monthly bill export & import, bill lifecycle and publish, and credit card & purchase order support; brokerage command & control with visibility into cost, capacity & ordering behavior across providers & customers; customer support with integration and support ticketing systems; catalog implementation of services & providers, pricing rules, sourcing content, import SLAs and terms & conditions; channel/portal management with click-through agreements, white labeling/co-branding and affiliate management; and provider self-service with catalog & list price updates and visibility into customer behavior.

A cloud services integration module 240 of the CSB platform 202 enables (e.g., via the CSB platform access portal) implementation of cloud services integration functionalities (i.e., via adapters and application programming interfaces (API's)). Examples of such cloud services integration functionalities include, but are not limited to, pre-built jCloud API based adapters; built jCloud and REST API based adapters; support for custom adapters; adapters map to a common model for provisioning changes and asset discovery; metadata-driven configuration options enable dynamic UI for provider capabilities (e.g., memory, cpu, storage, OS templates); and map provisioning tasks to be automated or workflow-based.

A business systems integrations module 242 of the CSB platform 202 enables (e.g., via the CSB platform access portal) implementation of business systems integration functionalities (i.e., via API's). Examples of such business systems integration functionalities include, but are not limited to, APIs for business intelligence systems (e.g., resource capacity/cost/utilization for provisioned resources; catalog data, asset inventory data and orders; and the like); enterprise billing & payment systems that provide APIs for enterprise billing & payment systems to retrieve and update data for bills, orders and assets; and APIs for cloud service providers to manage catalog & list prices, terms and conditions for provider services and visibility into customer activity and behavior.

An IT systems integrations module 244 of the CSB platform 202 enables (e.g., via the CSB platform access portal) implementation of IT systems integration functionalities (i.e., via API's) related to internal IT governance, internal IT operations help desk systems, and internal data center systems management. Examples of such IT systems integration functionalities include, but are not limited to, providing APIs for enterprise governance systems to view order access and complete workflow tasks, review tickets/support, terms and conditions with SLAs; monitoring and auditing data for cost, capacity and utilization of resources; providing APIs for Help Desk systems to view, edit, submit and run reports on support tickets; providing APIs for enterprise systems management integration; and monitoring data for cost, capacity, and utilization of resources.

A cloud services network module 246 of the CSB platform 202 enables (e.g., via the CSB platform access portal) implementation of cloud services networking functionalities. Examples of such cloud services networking functionalities include, but are not limited to, pre-defined CSB service taxonomy (e.g., hierarchical); pre-loaded catalog(s) (e.g., for cloud providers, private clouds, security services, network services, managed services; pre-built adapters for available cloud service providers; pre-defined provisioning workflows for all services pre-loaded in the catalog(s); sourcing comparator content for cloud service provider offerings; pre-defined subscription packages; user roles and dashboards; pre-defined email templates for user registration, provisioning status, order status & process steps, alert notifications, and task notifications; and pre-built integration for support.

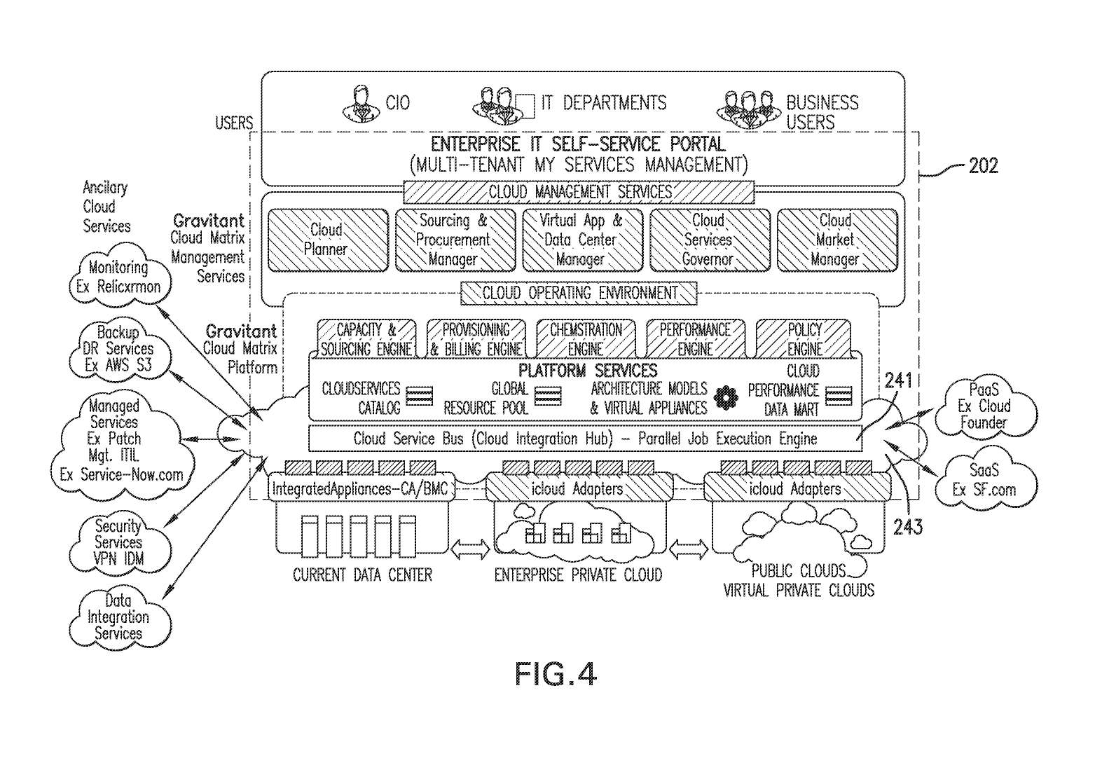

Referring to FIG. 4, further details of the cloud services integration module 240 of the CSB platform 202 are presented. The cloud services integration module 240 shown in FIG. 3A comprises a unique and comprehensive service bus architecture for the provisioning capabilities. This service bus architecture is embodied by the cloud service bus 241, which is coupled to outside network 243. The cloud service bus 241 has an inbuilt data driven workflow/process engine that supports multiple workflow/process definitions for different services, service providers and/or service types. The cloud service bus 241 uses an adapter architecture pattern to integrate with service providers. The cloud service bus 241 is a message-based architecture that allows asynchronous and parallel execution of provisioning tasks across cloud services and cloud service providers. These provisioning adapters are separate ‘classes/libraries’ that implement specific provisioning APIs at the level of each operation mapped to the provider API. The adapter classes are implemented using the Interface design pattern. The cloud service bus 241 supports multiple adapter invocation approaches including standard web service protocols and REST API protocols, as well as custom approaches depending on the service provider capabilities.

The cloud service bus 241 can use standard open-source JClouds (jclouds) protocol that currently has provisioning integration enabled for about 30 cloud providers. The cloud service bus 241 workflows invoke jclouds protocol libraries using service provider metadata and credentials configured in the catalog discussed above (i.e., the service catalog).

The architecture of the cloud service bus 241 and the adapter pattern support several standards such as, for example, VMWare vCloud Director APIs, OpenStack APIs, AWS APIs, jclouds APIs, Eucalyptus APIs and CloudStack APIs. The cloud service bus 241 provides the unique ability to interoperate with emerging and changing standards with the cloud, and normalize across them from a consumer perspective. Many of these standards are focused on cloud provider's ease of management of multiple cloud technologies.

Users of the CSB platform 220 can design their virtual data centers through a visual user friendly console. Once the design is finalized, it goes through an authorization workflow, followed by an approvals process that is all fully automated through the CSB platform 220. Such an authorization workflow is critical to maintain complete control of the procurement process. Otherwise, resources may be ordered and provisioned randomly without proper protocol leading to rogue virtual machines and virtual machine sprawl. Next, all the virtual resources are simultaneously provisioned across multiple providers through the cloud services integration module 240, which has API connections to the different cloud service providers. Accordingly, cloud service consumers do not need to create accounts and communicate with multiple providers for their cloud requirements because this will be done for them automatically by the cloud services integration module 240. This level of automation also allows for easy movement of workloads between cloud service providers.

FIG. 3A shows a functional component architecture view of the CSB platform 202 of FIG. 4. Platform services of 202 shows the data repositories that power the various functional components of FIG. 3A. For example, Cloud Performance Datamart in 202 is updated and used along with Performance Engine and Cloud Services Governor in 202 by the Control Functional module in FIG. 3A; and the Cloud Services Catalog, Discovery and Asset Manager in FIG. 3A uses the Platform services of 202 Global Services Catalog, Global Resource Pool, and Architecture Models and Virtual Appliances, along with Virtual App and Data center Manager Functions shown in 202. The Cloud Services Network module in FIG. 3A represents the catalog content, templates and adapters built for the representative network of services shown in FIG. 4 outside 202 and connected to 202.

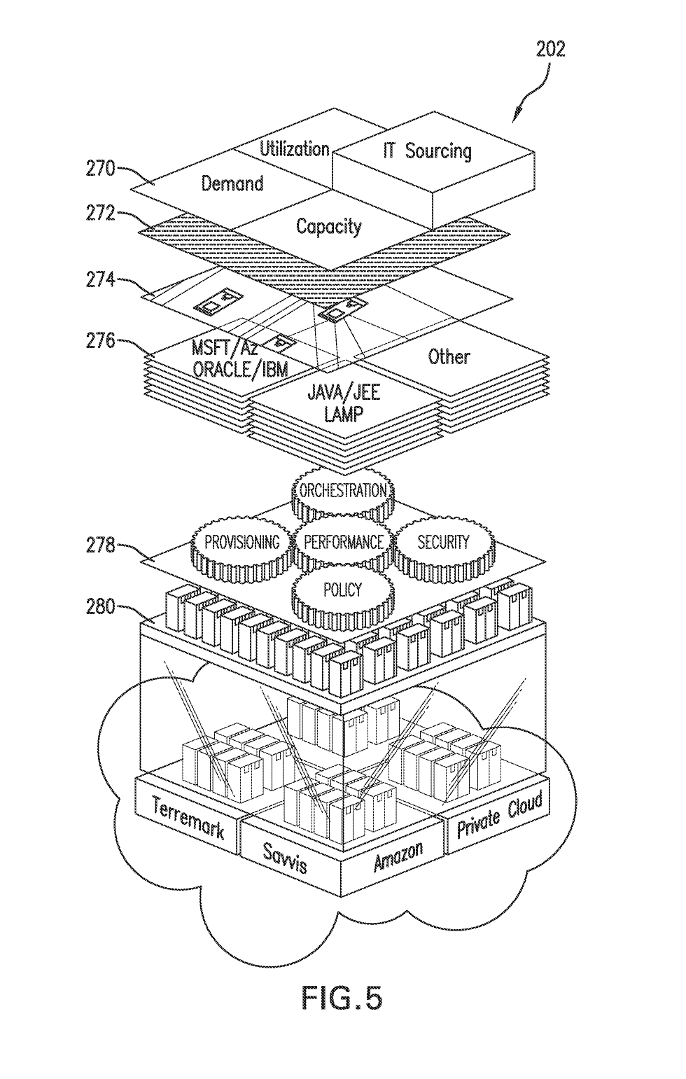

FIG. 5 shows an architectural view of the CSB platform 202. The architecture of the CSB platform 202 enables cloud brokerage services to be delivered in a manner that provides advantageous and beneficial results. As is discussed below in reference to the various platform engines of the CSB platform 202, the architecture of the CSB platform 202 employs advanced simulation and optimization mathematical models for IT planning, sourcing, and governance.

A set of cloud decision and governance engines 270 of the CSB platform 202 is configured to simulate and optimize trade-offs between cloud service criteria such as, for example, business demand, resource capacity, utilization/performance, and IT sourcing policies. The set of cloud decision and governance engines 270 enable the analysis of impacts to cloud service parameters such as, for example, cost, risk, QoS, SLAs, and application architecture for business services and applications. Based on these analyses, IT organizations and/or other entity(ies) of a cloud service consumer can make decisions on preferred cloud service providers to use, on the optimal cloud service capacity to deploy, and on the policies for automated scaling of capacity based on business demand. Thereafter, an IT organization and/or other entity(ies) of a cloud service consumer can govern the operations and compliance of these decisions through on-going tracking and analysis against a defined plan.

A cloud services catalog engine 272 of the CSB platform 202 is configured to manage a comprehensive model of public/private cloud services supply and business services demand of the cloud service consumer's. An administrative entity that manages back-end operability of the CSB platform 202 (i.e., the various platform engines thereof) works with many cloud service providers to model their individual cloud services and purchase-able line items with pricing and packaging structures. The cloud service consumer (e.g., its IT Organizations) can then define their business services and model demand for cloud services based on available services in a catalog of cloud services that are available from the cloud service providers (i.e., a CSB cloud services catalog). The cloud service consumer (e.g., its IT Organizations) can also define a custom catalog of preferred suppliers (e.g., a CSB cloud service provider catalog that can comprise the CSB cloud services catalog) to help manage their sourcing policies and setup a private marketplace.

A cloud performance data mart engine 274 of the CSB platform 202 is configured to automatically aggregate and correlate metrics for cloud service criteria such as, for example, demand, capacity, utilization, performance, cost, and risk for multiple application architecture and cloud resources across many environments and virtual data centers. The cloud performance data mart engine 274 enables near real-time visibility into resource performance along with audit data to manage governance of resource changes. Using a suitable performance data model, the system can scale to support thousands of resources with historical data and deliver instant reporting.

An application architecture manager engine 276 of the CSB platform 202 is configured to define application architecture blueprints using virtual appliances (e.g., templates) and associated resource capacity models to automate system construction, deployment, configuration and maintenance across physical, virtual and cloud environments. Also, the application architecture manager engine 276 enables orchestration and transaction-based automated provisioning of cloud resource changes.

A set of cloud architecture engines 278 of the CSB platform 202 provides a common set of architecture services to intelligently scale, monitor, and secure applications running across multiple cloud environments and internal data centers. The cloud architecture engines 278 provide the foundation, logic, and integrations to enable automated resource provisioning, performance management, orchestration and workflow, policy models, and security controls.

A global cloud resource pool and cloud service provider engine 280 of the CSB platform 202 is configured to create, manage and control VDC's by provisioning resources from multiple external cloud service providers, private clouds and internal data centers. All resources are inventoried globally across providers and manageable through a single unified interface. Cloud service providers are integrated into the CSB platform 202 through common interfaces (e.g., for connectors of VDC's and connectors of cloud managed services).

In view of the disclosures made herein, a skilled person will appreciate that a CSB platform configured in accordance with the present invention offers several distinguishing aspects with respect to traditional approaches for enabling a cloud services to be implemented by a cloud services consumer. One such distinguishing aspect relates to CSB functionality being configured for meeting end user cloud service consumption use cases integrated with governance use cases for IT and business managers. In this regard, such a CSB platform is configured to operate and scale across multiple agencies and internal/external cloud service providers communities in a centralized or federated deployment model. Another such distinguishing aspect relates to CSB platform being model driven and based on XML semantic ontologies. This avoids lock in for end customers while providing quick extensibility and integration with customers and cloud providers systems. Furthermore, the CSB platform includes integrated analytics and policy management for intelligent resource usage, SLA compliance, and cost optimization thereby allowing cloud service consumers to run predictive IT operations to optimize utilization cost and SLA across an IT supply chain. Yet another such distinguishing aspect relates to CSB platform being able to be deployed (i.e., onsite or offsite) in multiple configurations where an operator of the CSB platform can be an agency or a preferred service integration provider. Additionally, the processes implemented via the CSB platform inter-operate with service management and governance processes of other entities, which enables a staged extension of a non-broker-based operations model to a broker-based operations model.

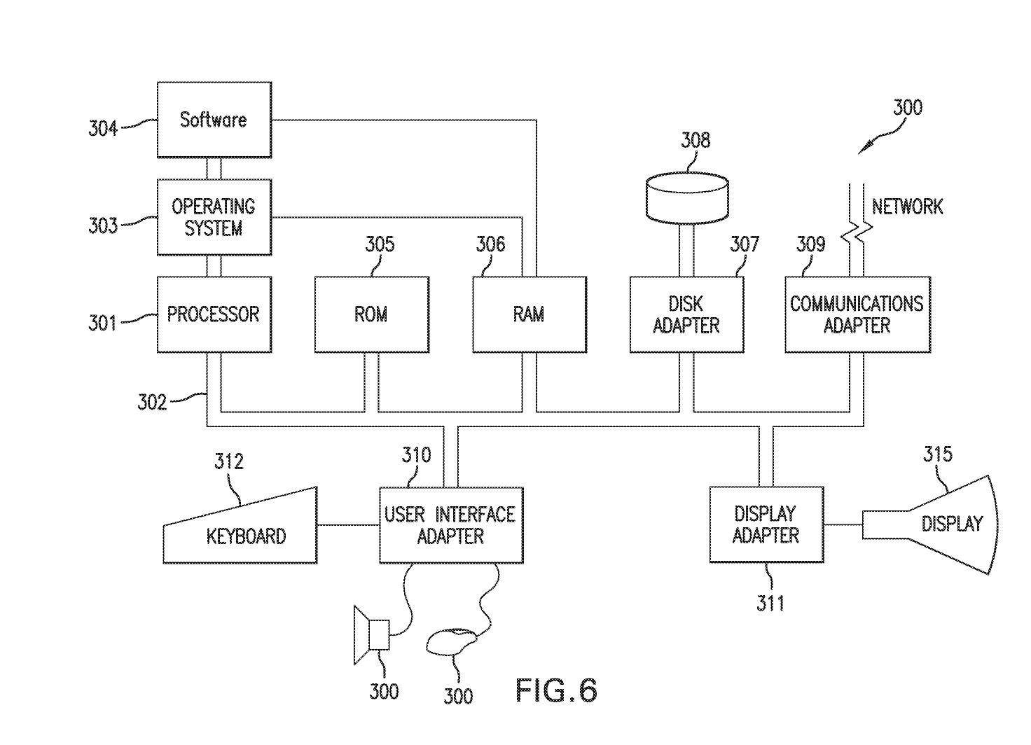

FIG. 6 shows a data processing system 300 representative of a hardware environment comprising a CSB platform configured in accordance with an embodiment of the present invention (e.g., the CSB platform 202). A server is one example of the data processing system 300. The data processing system 300 a processor 301 coupled to various other components by system bus 302. An operating system 303 runs on processor 301 and provides control and coordinates the functions of the various components of the data processing system 300. 2. Software 304 in accordance with the principles of the present invention runs in conjunction with operating system 303 and provides calls to operating system 303 where the calls implement the various functions or services to be performed by software 304 and, optionally, other applications. Software 304 includes a set of instructions (i.e., a program) for providing cloud service brokerage functionality configured in accordance with an embodiment of the present invention (e.g., as disclosed above in FIGS. 2-5).

Read-only memory (“ROM”) 305 is coupled to system bus 302 and includes a basic input/output system (“BIOS”) that controls certain basic functions of capacity planning system 104. Random access memory (“RAM”) 306 and disk adapter 307 are also coupled to system bus 302. It should be noted that software components including operating system 303 and software 304 can be loaded into RAM 306, which may be the main memory of execution for the CSB platform 202. Disk adapter 307 may be an integrated drive electronics (“IDE”) adapter that communicates with a disk unit 308, e.g., disk drive.

The data processing system 300 may further include a communications adapter 309 coupled to bus 302. Communications adapter 309 interconnects bus 302 with an outside network (e.g., outside network 243 shown in FIG. 4) enabling the CSB platform 202 to communicate with other devices.

I/O devices may also be connected to the CSB platform 202 via a user interface adapter 310 and a display adapter 311. Keyboard 312, mouse 313 and speaker 314 may all be interconnected to bus 302 through user interface adapter 310. Data may be inputted to the CSB platform 202 through any of these devices. A display monitor 315 may be connected to system bus 302 by display adapter 311. In this manner, a user is capable of inputting to the CSB platform 202 through keyboard 312 or mouse 313 and receiving output from the CSB platform 202 via display 315 or speaker 314.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are/can be described herein with reference to textual descriptions, flowchart illustrations and/or block diagrams of methods, apparatus (systems) and computer program products according to embodiments of the present invention. It will be understood that portions of the textual descriptions, flowchart illustrations and/or block diagrams, and combinations thereof can be implemented by computer program instructions. These computer program instructions may be provided to a processor of a general purpose computer, special purpose computer, or other programmable data processing apparatus to product a machine, such that the instructions, which execute via the processor of the computer or other programmable data processing apparatus, create means for implementing the function/acts specified in the textual descriptions, flowchart illustrations and/or block diagrams, and combinations thereof. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the textual descriptions, flowchart illustrations and/or block diagrams, and combinations thereof. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the textual descriptions, flowchart illustrations and/or block diagrams, and combinations thereof.

### Cloud Services Spending Analytics

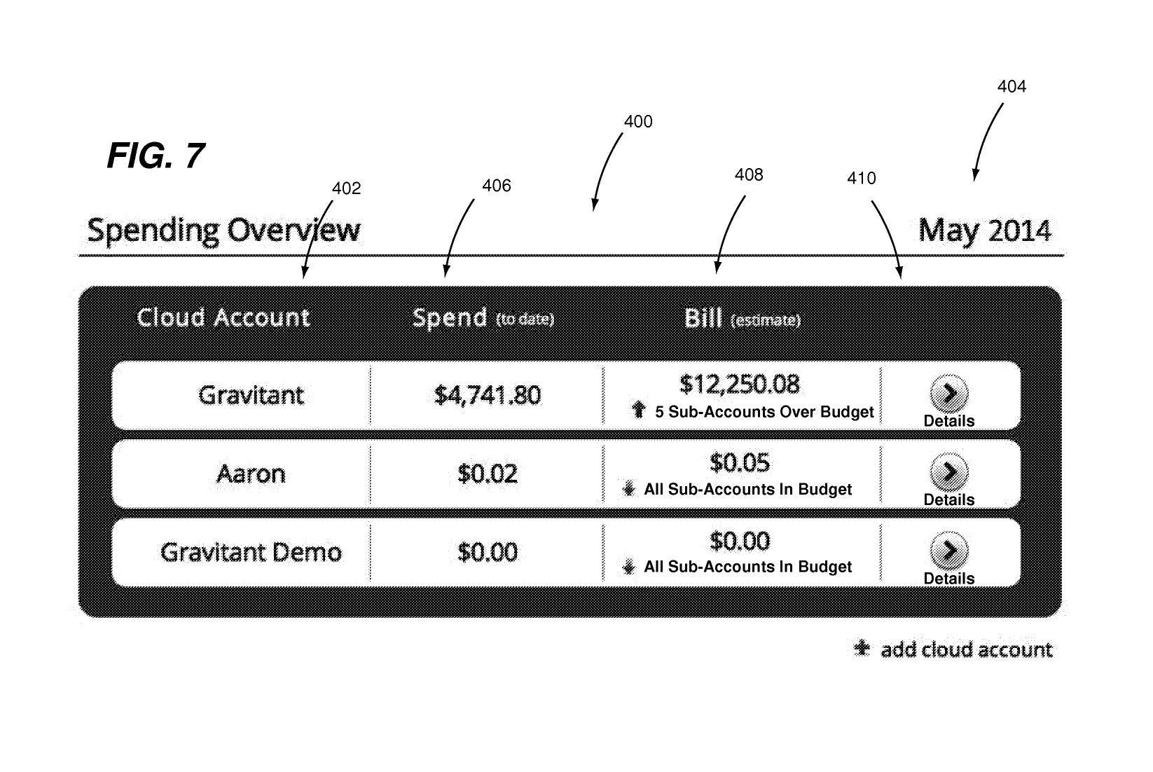

FIG. 7 shows a cloud account spending summary 400 configured in accordance with an embodiment of the present invention. The cloud account spending summary 400 includes various information relating to cloud service spending for a plurality of cloud accounts 402. For example, the cloud accounts 402 are accounts for different cloud service consumers within a business entity or the like. The cloud account spending summary 400 can be prepared and displayed in response to receiving a request for the cloud service spending information. The cloud accounts 402 can be configured to include cloud services all from a common cloud service provider (i.e., per-provider basis) or can be configured to include cloud services from two or more different cloud service providers (i.e., multi-provider). The cloud account spending summary 400 presents information for a selected time period 404 (e.g., selected month and year). In this respect, the cloud service spending information in the cloud account spending summary 400 is presented on a per-cloud account basis and per time period basis.

For each of the cloud accounts 402, the cloud account spending summary 400 includes a current amount spent 406 on cloud services for a particular one of the cloud accounts 402 and an estimated billed amount 408 for cloud services for a particular one of the cloud accounts 402 over an entire duration of the cloud services billing period 404. The current amount spent 406 on cloud services for the particular one of the cloud accounts 402 is the amount spent on the cloud services for a particular one of the cloud accounts 402 for a current day of the billing period 404 (e.g., the day the cloud account spending summary 400 is prepared and displayed) and all prior days of the billing period 404.

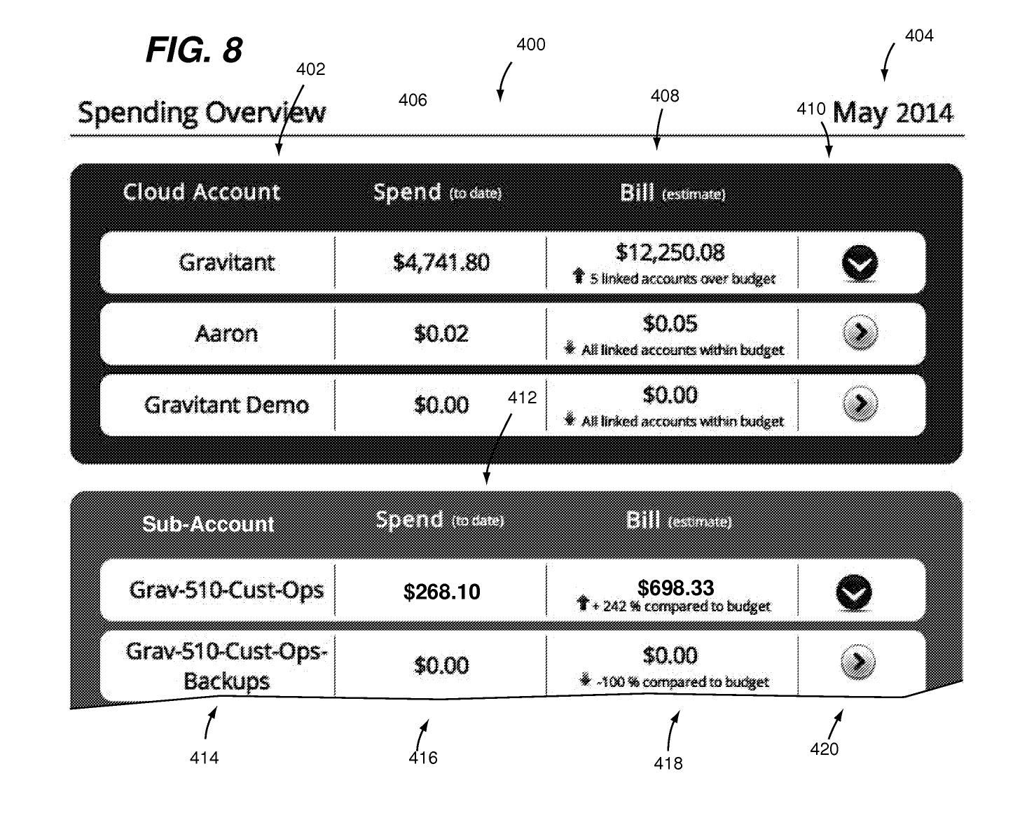

Referring now to FIGS. 7 and 8, for each of the cloud accounts 402, the cloud account spending summary 400 includes a sub-account display selector 410. Selection of the sub-account display selector 410 for a particular one of the cloud accounts 402 causes a cloud service consumer account spending summary 412 (FIG. 8) for the particular one of the cloud accounts 402 to be prepared and displayed. A plurality of cloud service consumer accounts 414 (i.e., referred to in FIG. 8 as sub-accounts) are associated with each one of the cloud accounts 402. The cloud service consumer accounts 414 are those that are implemented by various cloud service consuming entities associated with a respective one of the cloud accounts 402 (e.g., cloud services utilized by a respective department, organization, person, etc of a business entity).

The cloud service consumer account spending summary 412 includes a current amount spent 416 on cloud services for the particular one of the cloud service consumer accounts 414 and an estimated billed amount 418 for cloud services for the particular one of the cloud service consumer accounts 414 over an entire duration of the cloud services billing period 404. The current amount spent 416 on cloud services for the particular one of the cloud accounts 402 is the amount spent on the cloud services for a particular one of the cloud service consumer accounts 414 for a current day of the billing period 404 (e.g., the day the cloud service consumer account spending summary 412 is prepared and displayed) and all prior days of the billing period 404.

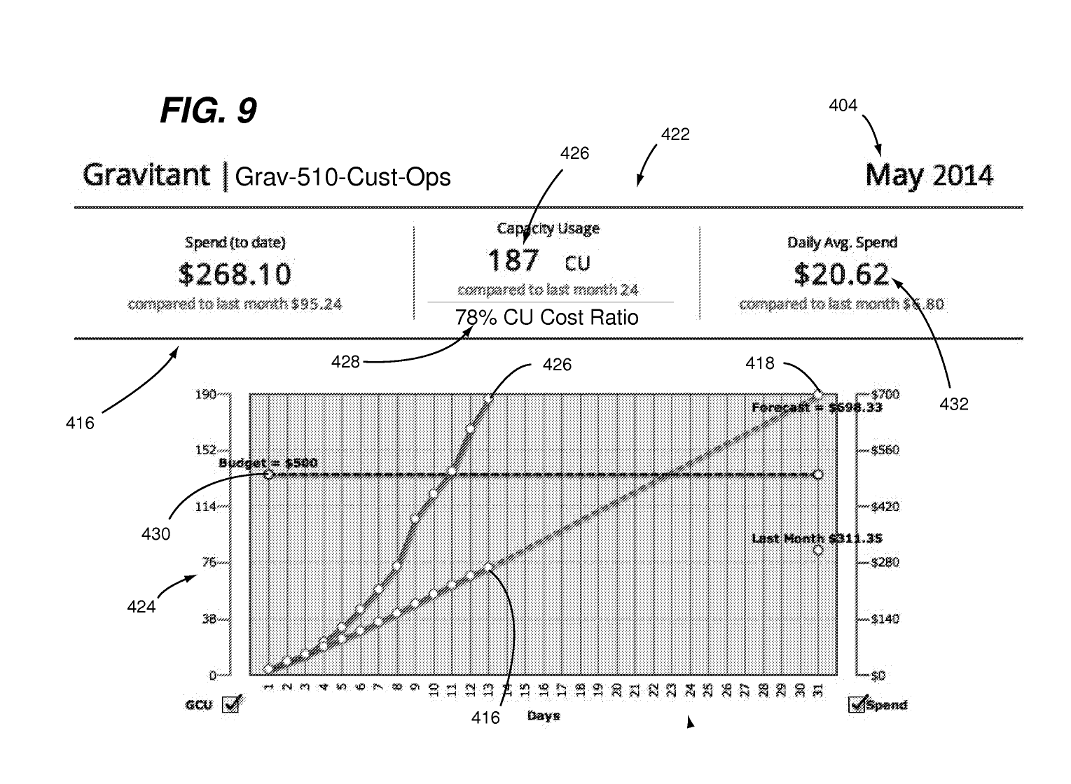

Referring now to FIGS. 8 and 9, for each of the cloud service consumer accounts 414, the cloud service consumer account spending summary 412 includes a sub-account overview display selector 420. Selection of the sub-account overview display selector 420 for a particular one of the cloud service consumer accounts 414 causes a sub-account overview 422 (FIG. 9) for the particular one of the cloud service consumer accounts 414 to be prepared and displayed. The sub-account overview 422 includes various information characterizing cost and usage (i.e., cost and usage characterizing information) relating to cloud services for the particular one of the cloud service consumer accounts 414. Example of the cost and usage characterizing information include, but are not limited to, the current amount spent 416 on cloud services for the particular one of the cloud service consumer accounts 414 and the estimated billed amount 418 for cloud services for the particular one of the cloud service consumer accounts 414 over an entire duration of the cloud services billing period 404. The current amount spent 416 and the estimated billed amount 418 can be shown in a numeric format and as data points on a cloud services data graph 424.

Other example of the cost and usage characterizing information in the sub-account overview 422 include, but are not limited to, a capacity usage value 426, a capacity usage cost efficiency value 428, a current time period cost budget value 430, and a daily average amount 432. As discussed below in greater detail, the capacity usage value 426, which can have units represented as CU (capacity unit), is a generic unit of IT capacity that characterizes multiple capacity-specific contributors of cloud services (e.g., processor speed, random access memory, storage, and bandwidth) that are allocated and billed on a usage basis. The capacity usage cost efficiency value 428 is a value that provides a comparison of an amount spent on the cloud services and the portion of the amount spent on cloud services that are allocated to capacity-specific contributors (e.g., processor speed, random access memory, storage, and bandwidth) of the cloud services. The current time period cost budget value 430 indicates a cost budget that has been allocated to the cloud services for the particular one of the cloud service consumer accounts 414 for the billing period 404. The daily average amount 432 is a value that characterizes the current amount spent 416 on cloud services for the particular one of the cloud service consumer accounts 414 on a per-day basis (i.e., number of days as defined by the current day plus all prior days of the billing period 404.

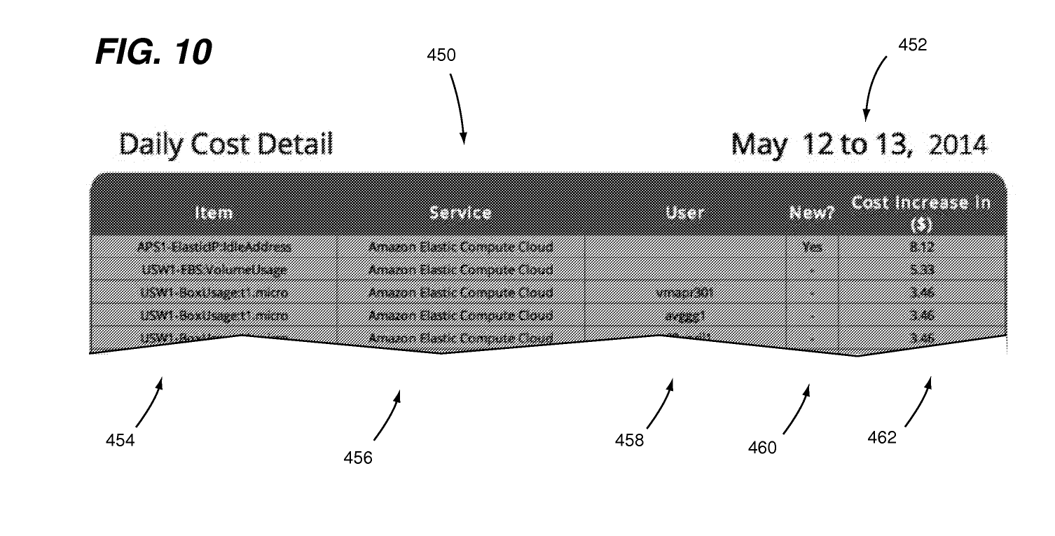

Referring now to FIG. 10, a daily cost ledger 450 configured in accordance with an embodiment of the present invention is shown. The daily cost ledger 450 can be displayed by selection of a data point on the cloud services data graph 424 that corresponds to the current amount spent 416 on cloud services for the particular one of the cloud service consumer accounts 414. The daily cost ledger 450 includes various information relating to the cost of the cloud services for the particular one of the cloud service consumer accounts 414 (i.e., cloud service consumer account cost characterizing information). The cloud service consumer account cost characterizing information represents incremental information for a daily period 452 corresponding to the data point on the cloud services data graph 424 that was selected for causing the cloud services data graph 424 to be prepared and displayed. Example of the cloud service consumer account cost characterizing information include, but are not limited to, a cloud cost contributing item 454, a cloud service description 456, a cloud service user 458, a cloud cost status indicator 460, and an incremental cost amount 462. The cloud cost contributing item 454 specifies a cloud service item that a component of the particular one of the cloud service consumer accounts 414 that is currently selected. The cloud service description 456 specifies a provider service that is servicing a respective cloud cost contributing item 454. The cloud service user 458 specifies an entity that is responsible for a respective cloud cost contributing item 454. The cloud cost status indicator 460 characterizes a status of a respective cloud cost contributing item 454 (e.g., is it a new item since a previous daily period). The incremental cost amount 462 indicates an amount that the respective cloud cost contributing item 454 has contributed to increasing the current amount spent for the particular one of the cloud service consumer accounts 414 that is currently selected.

Presented now is a discussion on determining the estimated billed amount (e.g., estimated billed amount 408 in FIGS. 7 and 8) for cloud services for a particular cloud account over an entire duration of a cloud services billing period. The estimated billed amount for cloud services for the particular cloud account is the sum of all of the estimated billed amounts (e.g., estimated billed amounts 418 in FIG. 8) for cloud services for all of the associated cloud service consumer accounts over the same cloud services billing period. In preferred embodiments, the estimated billed amount is computed using an end-of-month estimated billing amount prediction algorithm that is based on a modified exponential moving average (EMA) calculation. Output of the end-of-month estimated billing amount prediction algorithm (i.e., the estimated billed amount for a particular cloud service consumer account) is a function of daily incremental cost amount data (i.e., summation of the incremental cost amount 462 for the particular cloud service consumer account).

Advantageously, as discussed below in greater detail, a modified exponential moving average (EMA) calculation configured in accordance with an embodiment of the present invention applies a weighting factor in its entirety to an incremental cost amount for a current day of the cloud services billing period and applies a weighting factor remaining portion in an equally divided manner to the incremental cost amount for each day of the cloud services billing period prior to the current day. The weighting factor is a specified number that is equal to or less than 1 and the weighting factor remaining portion is a difference between 1 and the specified number. Weighting of the incremental cost amount for the current day in this manner with respect to the remaining incremental cost amount data allows the end-of-month prediction algorithm to be robust against dramatic changes in accumulated bill amounts (e.g., caused by cloud provider supplied credits). Another advantageous aspect of the end-of-month estimated billing amount prediction algorithm is the implementation of a forecast based on cumulative spend as opposed to forecasting spend of each resource independently and then summing it up, which eliminates a significant amount of forecast error.

As mentioned above, embodiments of the present invention include a ‘modified’ exponential moving average calculation. The modification comes in two parts. A first part of the modification relates to applying a unique weight (i.e., weighting factor x) on the most current data (i.e., incremental cost amount for a current day) while remaining data (i.e., all days (n) prior to the current day in the current billing period (i.e., n−1 data points)) have equally-divided weights (i.e., (1−x)/(n−1)). This is different from a typical exponential moving average calculation in which weights follow a linear or exponentially decreasing function. A second part of the modification relates to any data value used in the exponential moving average calculation must being greater than or equal to 0. In a typical exponential moving average calculation, negative values are allowed to affect output of the calculation. In contrast, because the modified exponential moving average calculation uses a cumulative spend amount, only non-negative values are included in the calculation. This modification improves forecasting error when negative data values are present.

In view of the disclosures made herein, a skilled person will appreciate that weighting factor on the most recent data point (i.e., incremental cost amount for the current day) scales in a non-linear way. For example, the weighting factor applied to the most recent data point may follow a relationship such as: 2 divided by (number of data points+1). Thus, on the first day of a cloud services billing period (i.e., a particular month), the end-of-month estimated billing amount prediction algorithm uses 2/(1+1)=1 or 100% of the most recent data point, uses 2/(2+1)=66% of the most recent data point on the second day, uses 2/(3+1)=50% of the most recent data point on the third day, and so on. The remaining weighting factor portion, which is applied to all data points except that for the current day (i.e., the remaining data points), is evenly divided among the remaining data points. As previously disclosed, if the weighting factor is expressed as ‘x’, the remaining weighting factor portion is expressed as ‘1−x’.

The estimated billed amount for cloud services for a particular cloud account over an entire duration of a cloud services billing period is determined by extrapolating from the total amount spend on cloud services on the current day out to the last day of the cloud services billing period. This extrapolation is performed using a billed amounted estimation slope that serves as a linear billed amount estimate from the total amount spend on cloud services on the current day until the end of the cloud services billing period. The billed amounted estimation slope can be determined by multiplying the incremental cost amount for the current day (i.e., the most recent data value ‘v’) and by the weighting factor x and adding this product and to the product of the average of the remaining data values (i.e., average of the incremental cost amounts for all days during the billing period that are prior to the current day) times the remaining weighting factor portion 1−x. Expressed as an equation, this is slope=(v*x)+(average (remaining data)*(1−x)).

As disclosed above, the weighting factor applied to the most recent data point can be follow a relationship such as: 2/(number of data points+1) where the value 2 is a weighting constant. In view of the disclosures made herein, a skilled person will appreciate that embodiments of the present invention are not limited to any particular weighting factor. For example, changing the weight constant can have a significant effect on the end-of-month estimated billing amount. In the depicted case presented above, setting the weight constant to 2 gives a significant weight on the most recent data point but does not over-allocate its emphasis on present data. The benefit of this is that the end-of-month estimated billing amount prediction algorithm is robust against large fluctuations in the incremental cost amount data and offers stability over a duration of a cloud services billing period. However, if the weight constant were increased to 4, for example, the end-of-month estimated billing amount prediction algorithm would offer a different characterization of the incremental cost amount data (e.g., better reflect its volatility).

Referring back to the discussion above in reference to FIG. 9 regarding the capacity usage value 426, it was disclosed that the capacity usage value is a generic unit of IT capacity that characterizes multiple capacity-specific contributors of cloud services that are allocated and billed on a usage basis. For example, in one specific implementation, a single capacity usage unit (i.e., 1 CU) corresponds to a cloud service capacity required to compute at a speed of 2.4 GHz with random access memory of 4 GB and local storage of 100 GB through 1 Mbps of bandwidth.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

What is claimed is:

1. A non-transitory computer-readable storage medium having tangibly embodied thereon and accessible therefrom instructions interpretable by at least one data processing device, the instructions are configured for causing the at least one data processing device to perform a method comprising:
determining and displaying an amount spent on cloud services for a cloud account, wherein the amount spent includes an amount spent on the cloud services for a current day of the cloud services billing period and all days of the cloud services billing period prior to the current day;
determining and displaying an estimated billed amount for cloud services for the cloud account over an entire duration of the cloud services billing period; and
determining and displaying a capacity cost parameter indicating a relationship between the amount spent on the cloud services and a portion thereof that is allocated to capacity-specific contributors of the cloud services.

2. The non-transitory computer-readable storage medium of claim 1 wherein:
a plurality of cloud service consumer accounts are associated with the cloud account; and
determining and displaying the amount spent on cloud services for the cloud account includes determining and displaying an amount spent on cloud services for each one of the cloud service consumer accounts.

3. The non-transitory computer-readable storage medium of claim 2, further comprising:
receiving selection of a particular one of the cloud service consumer accounts; and
in response to receiving the selection of the particular one of the cloud service consumer accounts, displaying a cloud service consumer account spending summary for the particular one of the cloud service consumer accounts, wherein the cloud service consumer account spending summary includes a current amount spent on cloud services for the particular one of the cloud service consumer accounts and an estimated billed amount for cloud services for the particular one of the cloud service consumer accounts over an entire duration of the cloud services billing period

4. The non-transitory computer-readable storage medium of claim 3 wherein determining and displaying the capacity cost parameter is performed for the particular one of the cloud service consumer accounts.

5. The non-transitory computer-readable storage medium of claim 1 wherein:
a plurality of cloud service consumer accounts are associated with the cloud account; and
determining and displaying the estimated billed amount includes determining and displaying an estimated billed amount for cloud services for each one of the cloud service consumer accounts over the entire duration of the cloud services billing period.

6. The non-transitory computer-readable storage medium of claim 5 wherein determining the estimated billed amount for cloud services for each one of the cloud service consumer accounts includes:
determining, on a daily basis for each day since a first day of a cloud services billing period, an incremental cost amount for the cloud services of a particular one of the cloud service consumer accounts;
applying a weighting factor in its entirety to the incremental cost amount for a current day of the cloud services billing period; and
applying a weighting factor remaining portion in an equally divided manner to the incremental cost amount for each day of the cloud services billing period prior to the current day.

7. The non-transitory computer-readable storage medium of claim 6 wherein:
the weighting factor is a specified number that is equal to or less than 1; and
the weighting factor remaining portion is a difference between 1 and the specified number.

8. The non-transitory computer-readable storage medium of claim 5, further comprising:
receiving selection of a particular one of the cloud service consumer accounts; and
in response to receiving the selection of the particular one of the cloud service consumer accounts, displaying a cloud service consumer account spending summary for the particular one of the cloud service consumer accounts, wherein the cloud service consumer account spending summary includes a current amount spent on cloud services for the particular one of the cloud service consumer accounts and an estimated billed amount for cloud services for the particular one of the cloud service consumer accounts over an entire duration of the cloud services billing period.

9. The non-transitory computer-readable storage medium of claim 8 wherein determining and displaying the capacity cost parameter is performed for the particular one of the cloud service consumer accounts.

10. The non-transitory computer-readable storage medium of claim 8 wherein determining the estimated billed amount for cloud services for each one of the cloud service consumer accounts includes:
determining, on a daily basis for each day since a first day of a cloud services billing period, an incremental cost amount for the cloud services of a particular one of the cloud service consumer accounts;
applying a weighting factor in its entirety to the incremental cost amount for a current day of the cloud services billing period; and
applying a weighting factor remaining portion in an equally divided manner to the incremental cost amount for each day of the cloud services billing period prior to the current day.

11. A non-transitory computer-readable storage medium having tangibly embodied thereon and accessible therefrom instructions interpretable by at least one data processing device, the instructions are configured for causing the at least one data processing device to perform a method comprising:
determining, on a daily basis for each day since a first day of a cloud services billing period, an incremental cost amount of cloud services for a cloud service consumer account; and
determining an estimated billed amount for the cloud services over an entire duration of the cloud services billing period, wherein determining the estimated billed amount includes applying a weighting factor in its entirety to the incremental cost amount for a current day of the cloud services billing period and applying a weighting factor remaining portion in an equally divided manner to the incremental cost amount for each day of the cloud services billing period prior to the current day.

12. The non-transitory computer-readable storage medium of claim 11 wherein:
the weighting factor is a specified number that is equal to or less than 1; and
the weighting factor remaining portion is a difference between 1 and the specified number.

13. The non-transitory computer-readable storage medium of claim 11, further comprising:
using the incremental cost amount for determining an amount spent on cloud services for the cloud service consumer account, wherein the amount spent includes an amount spent on the cloud services for a current day of the cloud services billing period and all days of the cloud services billing period prior to the current day;
determining a portion of the amount spent on cloud services that is allocated to capacity-specific contributors of the cloud services; and
determining a capacity cost parameter that provides a comparison of the amount spent on the cloud services and the portion of the amount spent on cloud services that are allocated to capacity-specific contributors of the cloud services.

14. The non-transitory computer-readable storage medium of claim 13 wherein:
the weighting factor is a specified number that is equal to or less than 1; and
the weighting factor remaining portion is a difference between 1 and the specified number.

15. A non-transitory computer-readable storage medium having tangibly embodied thereon and accessible therefrom instructions interpretable by at least one data processing device, the instructions are configured for causing the at least one data processing device to perform a method comprising:
receiving, on a current day of a cloud services billing period, a request for cloud service spending information for a cloud account, wherein the cloud account has a plurality of cloud service consumer accounts associated therewith;
preparing and displaying, in response to receiving the request for the cloud service spending information, a cloud account spending summary for the cloud account, wherein the cloud account spending summary includes a current amount spent on cloud services for the cloud service consumer accounts and an estimated billed amount for cloud services for the cloud service consumer accounts over an entire duration of the cloud services billing period; and
in response to receiving selection of a particular one of the cloud service consumer accounts, preparing and displaying a cloud service consumer account spending summary for the particular one of the cloud service consumer accounts, wherein the cloud service consumer account spending summary includes a current amount spent on cloud services for the particular one of the cloud service consumer accounts and an estimated billed amount for cloud services for the particular one of the cloud service consumer accounts over an entire duration of the cloud services billing period.

16. The non-transitory computer-readable storage medium of claim 15, further comprising:
in response to receiving a request for capacity usage information for the particular one of the cloud service consumer accounts, determining and displaying a capacity cost parameter indicating a relationship between the current amount spent on cloud services for the particular one of the cloud service consumer accounts and a portion thereof that is allocated to capacity-specific contributors of the cloud services.

17. The non-transitory computer-readable storage medium of claim 15 wherein preparing and displaying the cloud account spending summary for the cloud account includes determining and displaying an estimated billed amount for cloud services for each one of the cloud service consumer accounts over the entire duration of the cloud services billing period.

18. The non-transitory computer-readable storage medium of claim 17 wherein determining the estimated billed amount for cloud services for each one of the cloud service consumer accounts includes:
determining, on a daily basis for each day since a first day of a cloud services billing period, an incremental cost amount for the cloud services of a particular one of the cloud service consumer accounts;
applying a weighting factor in its entirety to the incremental cost amount for a current day of the cloud services billing period; and
applying a weighting factor remaining portion in an equally divided manner to the incremental cost amount for each day of the cloud services billing period prior to the current day.

19. The non-transitory computer-readable storage medium of claim 18 wherein:
the weighting factor is a specified number that is equal to or less than 1; and
the weighting factor remaining portion is a difference between 1 and the specified number.

20. The non-transitory computer-readable storage medium of claim 19, further comprising:
in response to receiving a request for capacity usage information for the particular one of the cloud service consumer accounts, determining and displaying a capacity cost parameter indicating a relationship between the current amount spent on cloud services for the particular one of the cloud service consumer accounts and a portion thereof that is allocated to capacity-specific contributors of the cloud services.
